(19) United States
(12) Patent Application Publication
(10) Pub. No.: US 2003/0024089 A1
(43) Pub. Date: Feb. 6, 2003

(54) Corrosion resistant metallic container and method of making and using the same

(76) Inventor: Mitchell Z. Dziekonski, Sugar Land, TX (US)

Correspondence Address: LOCKE LIDDELL & SAPP LLP, 600 TRAVIS, 3400 CHASE TOWER, HOUSTON, TX, 77002-3095, US

(21) Appl. No.: 09/923,014

(22) Filed: Aug. 3, 2001

(51) Int. Cl. A61G 17/00

(52) U.S. Cl. 27/1

(57) ABSTRACT

The present invention offers corrosion metallic resistant containers that may be used in a variety of environments, including outdoor, semi-outdoor, water, or marine environments without the concern of corrosion and fermentation problems seen in the prior art. In a preferred embodiment, the present invention may comprise titanium, nickel, cobalt, chromium, molybdenum, zirconium, similar metals, or alloys thereof, coatings of these metals. The use of these metals on or in containers such as urns, coffins, caskets, or similar containers offers greater options in the placement of the deceased. In a most preferred embodiment, an urn formed of titanium offers a preferred container for the cremated remains of a deceased human or animal. In a most preferred embodiment, the container may further include a compartment for the inclusion of objects.

### FIELD OF THE INVENTION

This invention relates to corrosion resistant containers including containers for use in the funeral and death care industry.

### BACKGROUND OF THE INVENTION

Containers for the remains of loved ones and animals of loved ones are known in the art. Notably, most of these containers have been fashioned from substances that discolor, degrade, or corrode over time. Sometimes, this degradation is helpful for environmental reasons. Though efforts have been made to incorporate paper, wood, plastics, copper, bronze, steels, and stainless steels in the design of these containers, there exists a need to provide a container comprised of a material that is corrosion resistant and is virtually immune to environments including but not limited to outdoor environments, semi-outdoor environments such as columbariums, niches, and mausoleums, water and marine environments.

In moisture rich environments, those skilled in the art have tried to alleviate the corrosion process by providing anodic corrosion protection in metal caskets. In these metal caskets, the embalming fluid and body deterioration can produce a fluid which is highly acidic and thus capable of corroding away the metals that are used present day coffin constructions. In order to retard such corrosion, anodes are connected to the metal container of the coffin. The anodic material such that it is more susceptible to corrosion than the base metal material of the coffin construction. The prior art, relying heavily on steel container, has used anodes made of magnesium The anodes are connected to the steel container and are preferentially corroded to protect the integrity of the low cost material of the metal container.

Furthermore, in the absence of embalming, physiological liquids soon flow from a corpse. When the coffin is buried, this problem is less visible that in the situation of coffins in mausoleums, where each coffin must be placed in niches such that each is inclined to allow drainage. A concern further exists that under a fermentation of the physiological liquids, an evolution of gas that would raise the pressure in the coffin and leak out in these embodiments.

Urns are currently limited to indoor environments, since they are also prone to corrosion attack that affects the aesthetic look of the unit. Urns can be manufactured from brass, bronze, copper, stone, or glass. Metallic urns made of steel, stainless steel, bronze, or copper are placed in vaults in outdoor crypts, but have a limited life in terms of corrosion resistance. Atmospheric conditions, as well as acid rain can have a degrading affect on the appearance of urns placed in an outdoor or marine environment. Moreover, biological organisms and their excretions may come into contact with the metals and corrode them

Moreover, outdoor, semi-outdoor, and water environments offer additional challenges. For example, the presence of chlorides or other halides can offer a corrosive situation in various alloys, such as stainless steels. The highly corrosive nature and widespread abundance of seawater and sea air have led to extensive efforts to find materials that are resistant to chlorides.

Commercial stainless steels are also subject to localized corrosion in stagnant seawater. Stagnant conditions arise when the flow rate over the metallic surfaces is less than about 1.2 to about 1.6 meters per second (about 3.9 to about 5.2 feet per second), when marine organisms are attached to the surfaces, or where crevices exist. Such conditions are very difficult to avoid completely in actual practice.

Thus, although general corrosion of stainless steel components tends to be very low in seawater, very serious damage leading to early failure often occurs because of localized corrosion. Discoloration, pitting attack, and penetration or perforation of stainless steels tend to take place on broad surfaces with low fluid flow rates, while some form of crevice corrosion takes place where there are imperfect contacts with mud, fouling substances, wood, paint, or other bodies, or even where there are reentrant angles or corners.

For example, the use of austenitic stainless steels for service in strong chloride environments has been difficult due to the possibility of chloride stress corrosion cracking. Under conditions of even moderate stress and temperature, type 304 (ordinarily 18% Cr 8% Ni) stainless steel will crack at very low chloride levels. Moreover, some of the metals used in prior art are magnetic. It is theoretically possible that a magnetic mine or similar magnetic object would be attracted to a current container disposed in the sea.

Therefore, a need exists to have corrosion resistant containers for our loved ones and animals of loved ones that can withstand a variety of environments, including outdoor, semi-outdoor, and water environments.

Titanium and its alloys are known in the industry to be resistant to corrosion. When exposed to oxygen, titanium is very reactive and tends to form a thin film of titanium oxide. This film is what gives titanium its strong resistance to corrosion. The layer of oxide even has the ability to “heal” itself after it has been scratched. After the metal has been scratched, a new layer of oxide will quickly form. Titanium is very stable over a wide range of pH and temperatures. For example, near nil corrosion has been shown in brine solutions ranging in pH from 3 to 11. In seawater, titanium has a corrosion rate of less than 0.0003 millimeters per year (mmpy). Also, the cracking problem that occurs with stainless steel is near non-existent with most commercial grade titanium and its alloys.

Titanium's corrosive abilities depend greatly on what other metals are contained in the alloy. For example, unalloyed titanium is virtually impervious to crevice corrosion up to 185° F. in organic type environments. By introducing molybdenum, palladium, and/or ruthenium to the titanium, the corrosion resistance is significantly increased beyond 185° F. Aluminum, vanadium, and other beta alloying elements can be added in order to make an alloy obtain higher mechanical properties.

Titanium's resistance to atmospheric, marine, groundwater, and biological microorganism corrosion has led to commercial exploitation of the material. Titanium has become a popular architectural resource. Additionally, titanium has been studied as possible containers for highly corrosive environments. In one instance, titanium containers are seen as a possible alternative to store nuclear waste. Also, the sewage control industry has studied the viability of using titanium containers. The food and drug industry has begun to study the viability of titanium containers. Titanium has been found to work well in the storage of food products because of its high resistance to corrosion and low propensity for contamination. Consequently, the quality of the stored product is maintained.

The commercial applications of titanium have not been fully exploited. The death care industry has yet to fully appreciate the benefits of titanium The same qualities of titanium that have benefited other industries can benefit the death care industry. Loved ones can rest assured knowing that the deceased will be in a container whose quality will not diminish over time.

### SUMMARY OF THE INVENTION

The present invention offers corrosion resistant containers that may be used in a variety of environments, including outdoor, semi-outdoor, water, and marine environments without the concern of corrosion and fermentation problems seen in the prior art. In a preferred embodiment, the present invention may comprise titanium, nickel, cobalt, zirconium, chromium, molybdenum, similar metals, or alloys thereof and/or a coating of these metals or alloys.

The use of these metals in containers such as urns, coffins, caskets, or similar containers offers greater options in the placement of the deceased. In a most preferred embodiment, an urn formed of titanium offers a preferred container for the cremated remains of a deceased human or animal. In a most preferred embodiment, the container may further include a compartment for the inclusion of objects. Titanium and its alloys can be applied to the surface of a metallic container by ion nitriding, implantation, plasma spraying, and or plating.

The metals and their principal alloys taught in this invention are nonmagnetic, virtually immune to corrosive elements such as seawater, and relatively lightweight. The container may include other alloying elements such as aluminum, iron, manganese, niobium, palladium, ruthenium, silicon, tantalum, tin, vanadium, and/or yttrium.

### BRIEF DESCRIPTION OF THE DRAWINGS

The accompanying drawings, which are incorporated in and form a part of the specification, illustrate the embodiments of the present invention, and, together with the description, serve to explain the principles of the invention. In the drawings:

FIG. 1 is a side view of an embodiment of a assembled container for a deceased person or animal;

FIG. 2 is a side view an embodiment of a assembled container for a deceased person or animal;

FIG. 3 is a top view an embodiment of a assembled container for a deceased person or animal;

FIG. 4 is a side view an embodiment of a assembled container for a deceased person or animal;

FIG. 5 is an exploded, cross-sectional side view of a portion of an embodiment of a container for a deceased person or animal;

FIG. 6 is a side view of another embodiment of a container for a deceased person or animal;

FIG. 7 is an exploded, cross-sectional side view of an embodiment of a container for a deceased person or animal;

FIG. 8 is a cross-sectional, side view an embodiment of a assembled container for a deceased person or animal;

FIG. 9 is bottom view an embodiment of a assembled container for a deceased person or animal;

FIG. 10 is an exploded, side view of an embodiment of a container for a deceased person or animal at least partially disposed in the ground.

It is to be noted that the drawings illustrate only typical embodiments of the invention and are therefore not to be considered limiting of its scope, for the invention encompasses other equally effective embodiments.

### DETAILED DESCRIPTION OF PREFERRED EMBODIMENT

The present invention is described with reference to a preferred embodiment of a corrosion resistant container capable of holding a deceased person or animal. Though these embodiments show containers in the forms of urns for containing the cremated remains of a human or animal, those skilled in the art will realize that corrosion resistant coffins, caskets, or similar containers are within the scope of the invention.

As shown in FIG. 1, a side view of an assembled, preferred embodiment of a container 10 is displayed. Container 10 typically comprises a body 11, a cap 12, and a second cap sometimes referred to as a base 13. As shown herein, a variety of designs or shapes may be incorporated into body 11, a cap 12, and a base 13. A preferred shape for body 11 is a cylinder having a cavity formed within body 11 capable of holding the remains of at least one deceased human or animal. This body 11 may be attached, secured, or otherwise connected to each cap 12 and base 13.

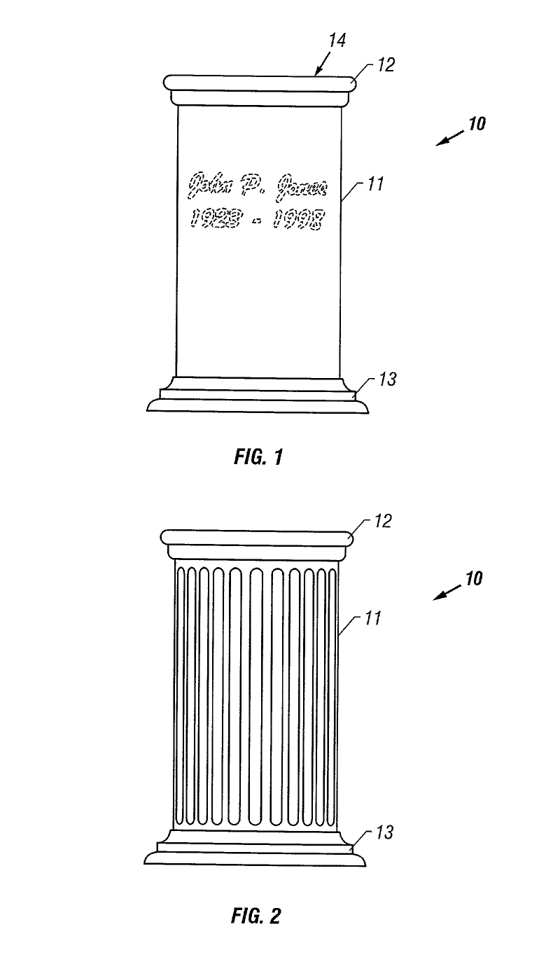

Body 11 may be formed in any shape. The cylindrical shape shown in FIG. 1 is preferable for strength and ease of formation. The indicia or writing shown on body 11 is only illustrative of the identification, stylistic, or ornamental materials that may be displayed on body 11. Referring to FIG. 2, another side view of an embodiment is shown. The ornamental design of body 11 of container 10 shows some of the possibilities in design that may incorporated into the container for stylistic, ornamental, or aesthetic purposes.

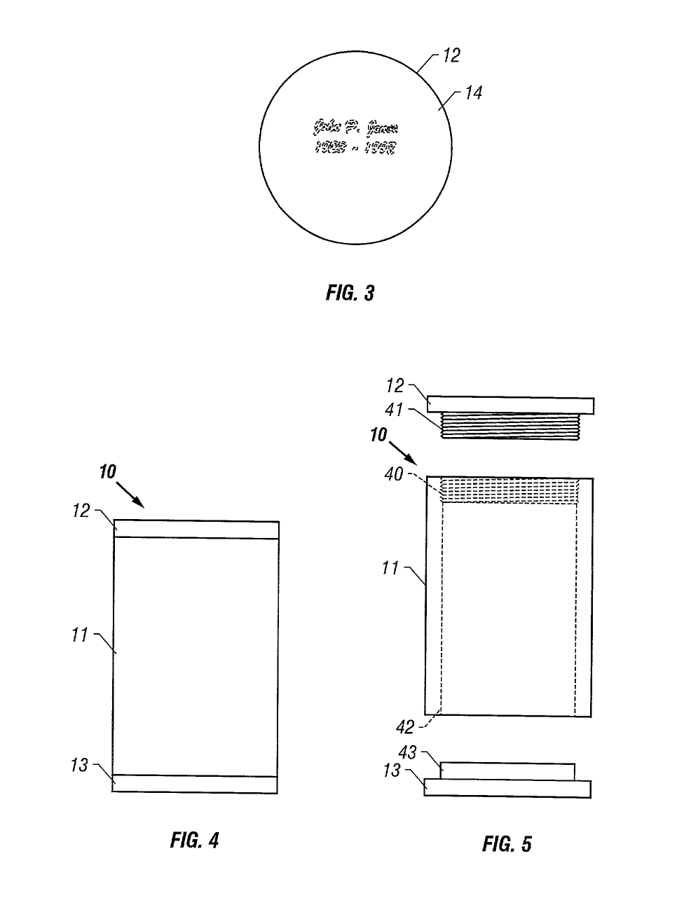

It is envisioned that visual indicia may include script or other written information that may include identification information, pictures, scenes, designs, or even portraits or pictures. Though discussed in greater detail below, any visual indicia on any portion of the container 10 may be applied by any method known to those skilled in the art including but not limited to milling, etching, laser etching, chemical etching, machining, chemical milling, cold or hot working blasting processes such as peening, and/or blasting. In this embodiment, indicia or writing may be disposed on other parts of the invention, such as the top surface 14 of the cap 12 as shown in FIG. 3, a top view of the container 10.

As shown in an assembled and a cross-sectional, exploded condition in FIGS. 4 and 5, respectively, the container 10 has a body 11 that is preferably formed with threads 40 formed in top portion of body 11. These threads 40 offer a preferred mechanism for securing the cap 12, also having threads 41 formed therein, to the body 11. Additional methods of securement are disclosed herein. In the event that a second cap is used, herein base 13, it may be connected to the body 11 in a similar manner. In this embodiment, the bottom portion 42 of body 11 is formed such that it may engage the top portion 43 of base 13 in a press-fit engagement. Those skilled in the art will recognize that virtually any means of securing each cap and base to the body 11 is considered to be within the scope of the invention. By example only, it is envisioned that bolts, fasteners, welds, press or shrink fit, screws, hinges, adhesives, and similar securing means are within the scope of the invention.

If included, the second cap referred to as base 13 is preferably formed such that it provides a foundation for the container 10 to be placed or rest upon another surface. Base 13 may be formed in an endless variety of shapes. For example, it may be preferable for base 13 to include a flat surface such that container 10 may be placed on a mantle. In the alternative, base 13 may include a spike, bolt, or similar anchoring mechanism capable of securing container 10 in place. In a most preferred embodiment, base 13 of container 10 comprises a securing shape such that container 10 may be secured on the bottom of the ocean.

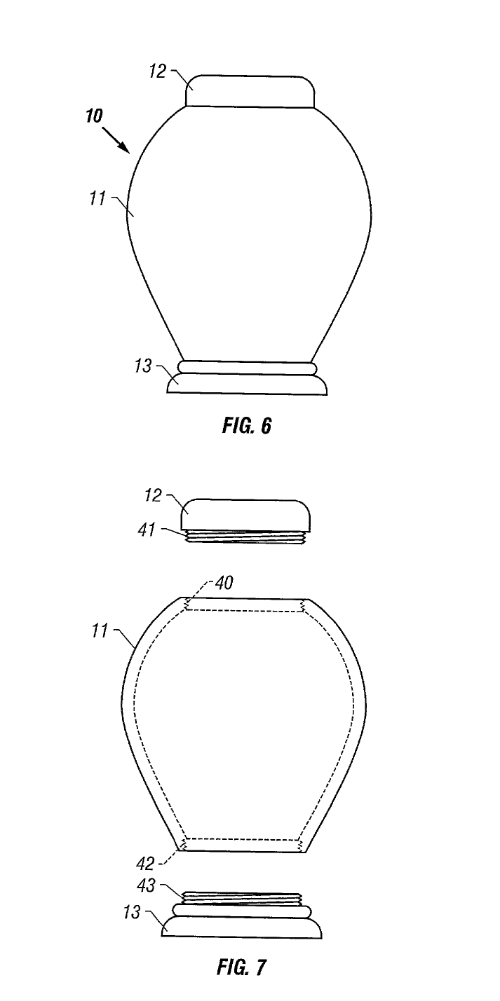

In addition to this embodiment, numerous other embodiments of container 10 may be formed that are within the scope of the invention. For example, FIGS. 6 and 7 show an alternative embodiment in a side view and a cross-sectional, exploded condition, respectively. Notably, the threaded engagement of the bottom portion 41 of cap 12 with the top portion 40 of body 11 is replicated in the second cap, base 13 wherein the bottom portion 42 of body 11 may engage the top portion 43 of base 13 in a threaded engagement. Those skilled in the art will recognize that this embodiment could also benefit from the inclusion of visual indicia or identification as previously discussed.

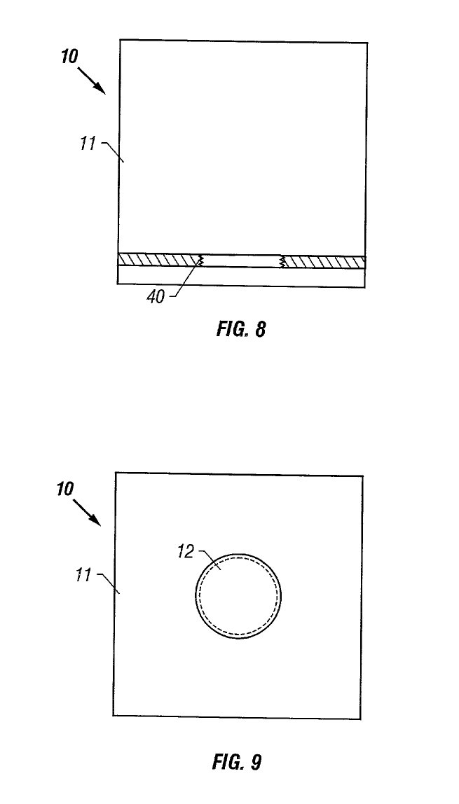

Additionally, another embodiment is shown in FIGS. 8 and 9 wherein the container 10 is shown in a cross-sectional side view and a bottom view, respectively. This embodiment illustrates the scope of the invention by showing that the body 11 may be formed in a variety of forms such that a single cap 12 may be disposed with body 11 to form the sealed condition. By forming the body 11 as such, the cap 12 may be engaged with the body 11, herein shown by illustration as a threaded engagement, to form the seal discussed herein.

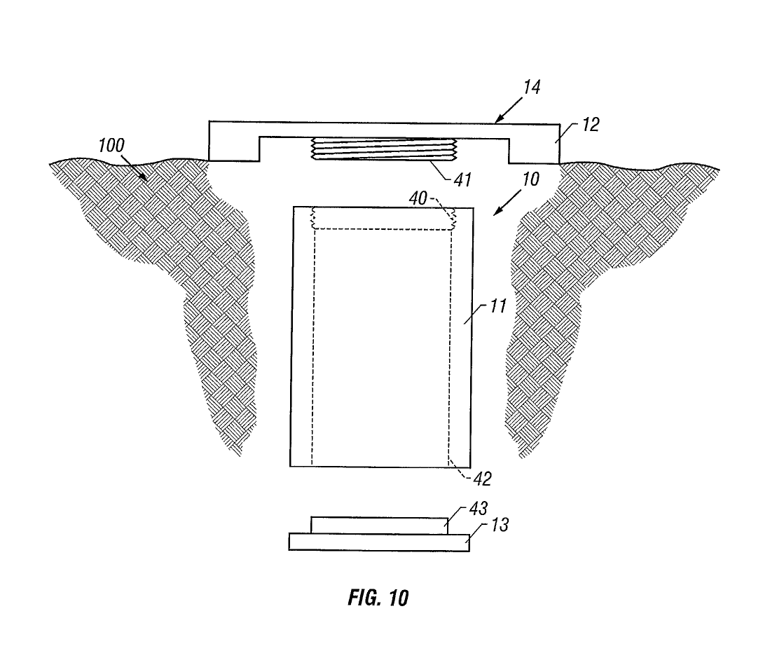

FIG. 10 shows a container 10 at least partially disposed in the ground 100. It is envisioned that at least one visual indicia may be disposed on the top 14 of the cap 12 such that identification or ornamental aspects may be shown therein. The corrosion resistant characteristics of the container 10 will allow the container 10 to be disposed in this outdoor environment for extended periods.

There are several ways to make this container. One method would be to use tubular rolled sheets of titanium alloy, which can then be cut and welded together into the desired shape. Another possible method would be to the process of hot working extruded pieces. Additionally, it may be machined from a solid bar. Yet another method would be to cast the appropriate shape. A preferred method of forming the container is rendering a hot-formed tube through the extrusion or piercing process. Subsequent operations, such as heat treatment and final conditioning to the titanium surface, would be applicable. Machining and or grinding would determine the final dimension of the container. Blasting the surface container can generate a texture conducive to the retail market.

The caps may be cast or machined from a solid bar. Those skilled in the art will recognize that these methods are illustrative of the methods of making the present invention and the scope should not be limited thereto.

Titanium alloys come in many varied forms. The following metals can be combined with titanium to form commercially functional alloys: aluminum (Al), chromium (Cr), cobalt (Co), iron (Fe), manganese (Mg), molybdenum (Mo), nickel (Ni), niobium (Nb), palladium (Pa), ruthenium (Ru), silicon (Si), tantalum (Ta), tin (Sn), vanadium (V), yttrium (Y), zirconium (Zr). Some of these alloys include: Alpha Alloys such as ASTM Grade 12, 5AL—2.5SN, 5AL—2.5SN—(ELI), 5AL—5ZR—5SN, 8AL—1MO—1V; Beta Alloys such as 3AL—8V—6CR—4MO—4Z, 15V—3AL3CR—3SN, Timet's Alloy sold under the trademark BETA 21—S, LCB, 13V—11CR—3AL; Alpha-Beta Alloys such as, 3AL—2.5V, 10—V—2FE—3AL, 6AL—2SN—4ZR—2MO, 6AL—4V, 6AL—4V—(ELI), 6AL—6V—2SN, 6AL2SN—2ZR—2MO—2CR, 6AL—2SN—4ZR—6MO, 6AL—7NB, 7AL—4MO, 8MN; and/or commercially pure Grades such as commercially pure ASTM Grade 1, Grade 2, Grade 3, Grade 4, Grade 7, Grade 13, Grade 14, Grade 15, Grade 16, Grade 17 and Grade 18.

Though these grades are preferable, all additional grades and even nonstandard grades comprising titanium, nickel, cobalt, chromium, zirconium, chromium and/or molybdenum are considered to be within the scope of the invention. As a matter of course, it is not uncommon for some or all of these alloys to comprise the following percentages of elements may be found within the chemical composition of alloys in the following amounts: up to about 8.5% (Al), up to about 12% chromium (Cr), up to about 2.2% iron (Fe), up to about 9.0% manganese (Mg), up to about 15% molybdenum (Mo), up to about 3.2% niobium (Nb), up to about 0.25% silicon (Si), up to about 3.0% tin (Sn), up to about 6% vanadium (V), up to about 0.005% yttrium (Y), up to about 7.5% zirconium (Zr), and other elements with the balance being titanium

In a preferred embodiment, the container either comprises greater than or about 49% by weight of titanium, greater than or about 12% by weight of nickel, greater than or about 0.3% by weight of cobalt, greater than or about 49% by weight of zirconium, greater than or about 16% by weight of chromium, or greater than or about 1.5% by weight of molybdenum or has a coating with any amount by weight of titanium, greater than or about 12% by weight of nickel, greater than or about 0.3% by weight of cobalt, greater than or about 16% by weight of chromium, greater than or about 1.5% by weight of molybdenum, or any amount by weight of zirconium In a most preferred embodiment, it is envisioned that the coating would have a thickness of at least about 0.5 mils thickness.

In a most preferred embodiment, the container may further include a compartment for the inclusion of objects. The compartment should be versatile enough to hold many kinds of objects. One such object would be a small family heirloom Perhaps an object that was significant to the deceased (i.e. jewelry, pictures). Additionally, the compartment would be able to hold a DNA sample such as a lock of hair. The compartment's function is to act as a time capsule. Therefore, anything that would be significant to give information to future people might be included. Additionally, the inclusion of visual indicia including but not limited to etching such as laser etching is within the scope of the invention. Different techniques include but are not limited to milling, blasting, chemical etching, and similar methods.

Having described the invention above, various modifications of the techniques, procedures, material and equipment will be apparent to those in the art. It is intended that all such variations within the scope and spirit of the appended claims be embraced thereby.

What is claimed is:

1. A corrosion resistant metallic container capable of holding the remains of a deceased human or animal in a sealed condition wherein the container comprises:
a body; and
at least one cap;
wherein the body and each cap comprises greater than or about 49% by weight of titanium, greater than or about 12% by weight of nickel, greater than or about 0.3% by weight of cobalt, greater than or about 49% by weight of zirconium, greater than or about 16% by weight of chromium, or greater than or about 1.5% by weight of molybdenum; and
wherein each cap is capable of engaging the body to form the sealed condition.

2. The container of claim 1 wherein the container is an urn.

3. The container of claim 1 further comprising at least one visual indicia.

4. The container of claim 1, wherein the container comprises a base cap wherein the base cap is capable of sealing engaging the body in a press-fit relationship.

5. The container of claim 1, wherein at least one cap has a cap threaded bottom and the body has a body threaded top capable of sealing engaging the cap threaded bottom of the cap.

6. The container of claim 1, further comprising at least one compartment.

7. A method of making a corrosion resistant container capable of containing the remains of a deceased human or anal in a sealed condition which comprises the steps of:
(a) forming a body;
(b) forming at least one cap; and
(c) engaging each cap to the body such that the container is in a sealed condition;
wherein the body and each cap comprises greater than or about 49% by weight of titanium, greater than or about 12% by weight of nickel, greater than or about 0.3% by weight of cobalt, greater than or about 49% by weight of zirconium, greater than or about 16% by weight of chromium, or greater than or about 1.5% by weight of molybdenum.

8. The method of claim 7, wherein Step (c) further comprises press-fitting at least one cap to the body.

9. The method of claim 7, wherein Step (a) further comprises rolling a sheet to form a tubular shape body.

10. The method of claim 7, which further comprises heat-treating the container.

11. The method of claim 7, which further comprises machining the container.

12. The method of claim 7, which further comprises blasting after Step (c).

13. The method of claim 7, wherein the container formed is an urn.

14. A method of using a corrosion resistant metallic container capable of holding the remains of a deceased human or animal in a sealed condition, the method which comprises the steps of:
(a) placing the remains in the container; and
(b) sealing the container;
wherein the container comprises greater than or about 49% by weight of titanium, greater than or about 12% by weight of nickel, greater than or about 0.3% by weight of cobalt, greater than or about 49% by weight of zirconium, greater than or about 16% by weight of chromium, or greater than or about 1.5% by weight of molybdenum

15. The method of claim 14, which further comprises:
(c) placing the container in an outdoor, semi-outdoor, water, or marine environment.

16. A method of using a corrosion resistant metallic container capable of holding the remains of a deceased human or animal in a sealed condition, wherein the container has an exterior surface, the container comprising:
a body; and
at least one cap;
wherein each cap is capable of engaging the body to form the sealed condition; and
wherein the exterior of the container comprises a coating, wherein the coating comprises an amount by weight of titanium, greater than or about 12% by weight of nickel, greater than or about 0.3% by weight of cobalt, greater than or about 16% by weight of chromium, greater than or about 1.5% by weight of molybdenum, or any amount by weight of zirconium

17. The container of claim 16, wherein the container is an urn.

18. The container of claim 16, wherein the body is cylindrical.

19. The container of claim 16, wherein the container comprises a base cap wherein the base cap is capable of sealing engaging the body in a press-fit relationship.

20. The container of claim 16, wherein at least one cap has a cap threaded bottom and the body has a body threaded top capable of sealing engaging the cap threaded bottom of the cap.

21. The container of claim 16, wherein the coating is at least about 0.5 mils thick.

22. A method of making a corrosion resistant container capable of containing the remains of a deceased human or animal in a sealed condition which comprises the steps of:
(a) forming a body;
(b) forming at least one cap; and
(c) engaging each cap to the body such that the container is in a sealed condition;
wherein the body and each cap comprises an amount by weight of titanium, greater than or about 12% by weight of nickel, greater than or about 0.3% by weight of cobalt, greater than or about 16% by weight of chromium, greater than or about 1.5% by weight of molybdenum, or any amount by weight of zirconium

23. The method of claim 22, wherein the container formed is an urn.

24. The method of claim 22, which further comprises:
(c) placing the container in an outdoor, semi-outdoor, water, or marine environment.
